(19) United States
(12) Patent Application Publication
(10) Pub. No.: US 2014/0092053 A1
(43) Pub. Date: Apr. 3, 2014

(54) INFORMATION DISPLAY ORIENTATION CONTROL USING PROXIMITY DETECTION

(71) Applicant: STMICROELECTRONICS ASIA PACIFIC PTE LTD, Singapore (SG)

(72) Inventors: Chee Yu Ng, Singapore (SG); Ys On, Singapore (SG); Ravi Bhatia, Singapore (SG)

(73) Assignee: STMicroelectronics Asia Pacific Pte Ltd, Singapore (SG)

(21) Appl. No.: 13/632,241

(22) Filed: Oct. 1, 2012

(51) Int. Cl. G06F 3/045; G06F 3/041

(52) U.S. Cl. 345/174; 345/173

(57) ABSTRACT

A display screen is configured to display information with a selectable one of many information display orientations. A touch screen panel of a touch screen system is positioned to overlie the display screen. The touch screen system operates to make a proximate touch detection, for example by a body part or stylus. A controller receives the proximate touch information from the capacitive touch screen system and interprets the proximate touch information to determine an indication from a user of a selection of an information display orientation for the display screen. The controller then controls the display screen to present information in accordance with the user selected information display orientation. The user selected information display orientation via the proximate touch detection will over-ride any other selected information display orientation such as a selection made in response to an orientation identified by an accelerometer or other gravity influenced sensor.

### TECHNICAL FIELD

The present invention relates to touch screen display systems and, in particular, to a system for controlling the display orientation on a touch screen display in response to a proximity detection.

### BACKGROUND

Portable electronic devices such as smart phones or tablet computers include a display screen to visually present information such as text and graphics. The portable nature of such devices permits the user to view the display screen in a number of information display orientations, the most basic of which (with a rectangularly formatted display screen) comprise a portrait orientation (where the longer edge of the screen is vertical) and a landscape orientation (where the shorter edge of the screen is vertical). The user's selection of information display orientation may be influenced by the type of information presented on the display screen. For example, when looking at a text document, the user may prefer the portrait orientation. Conversely, when watching a movie, the user may prefer the landscape orientation.

In some prior art devices, the user may manually enter a selection for information display orientation on the display screen through a configuration utility. Improvements in device configuration, however, have made the information display orientation selection more automatic. For example, the device may automatically select an information display orientation for the display screen based on the type of information that is being visually presented. So, if the user is viewing a text document, the device will automatically select the portrait orientation. Conversely, if the user is viewing a movie, the device will automatically select the landscape orientation. Of course, the configuration utility of the device remains available to the user to over-ride the automatic selection of the information display orientation.

A further improvement in the operation for automatic selection of information display orientation on a display screen bases the information display orientation selection on a sensed orientation of the portable electronic device itself. So, if the portable electronic device senses that the user is holding the portable electronic device in a manner where the display screen has a portrait orientation, an automatic selection is made to present the information with a corresponding portrait orientation. Conversely, if the portable electronic device senses that the user is holding the portable electronic device in a manner where the display screen has a landscape orientation, an automatic selection is made to present the information with a corresponding landscape orientation. An accelerometer or other gravity influenced sensor device is typically incorporated into the portable electronic device to provide information indicative of the held orientation of the portable electronic device itself, with the processing unit and display driver circuitry of the portable electronic device interpreting the sensed information to make a corresponding selection of information display orientation for presentation of information to the user on the display screen.

There are instances, however, where the information indicative of the held orientation of the portable electronic device itself is ambiguous or perhaps incorrect with respect to making an information display orientation selection. Take, for example, the situation where a smart phone or tablet computer is laid flat on a table. In this situation, the accelerometer or other gravity influenced sensor device cannot provide sufficient information for making the information display orientation selection. The default in such a case is to maintain the previously selected information display orientation for the display screen until the sensor would indicate that a different orientation selection is required. If there is a single user viewing the device, this inability of the sensor to provide information for use in making the information display orientation selection is of no consequence since the user can orientate himself to the display screen in accordance with the previously selected information display orientation. However, where there are multiple users surrounding the device laid flat on a table, each user having a different viewing angle with respect to the display screen, there is a significant issue with respect to selecting the information display orientation over time based on the information being displayed and the user desiring to correctly view that information.

As another example, consider the situation where a user is lying down on their back holding the portable electronic device over their head. In this situation, the accelerometer or other gravity influenced sensor device may provide device orientation information which is indeed opposite the user's point of view. So, in this case the selected information display orientation will present the displayed information on the display screen upside-down with respect to the user's viewing position.

Of course, the configuration utility of the device could be used to make different information display orientation selections by the user or users, but this is cumbersome and may be incompatible with the information being displayed (for example, when alternating turns on a multi-player game). There is a need in the art for an easy way for a user to over-ride the information display orientation selection sensor of a portable electronic device and exercise control over selection of the information display orientation.

### SUMMARY

In an embodiment, a system comprises: a display screen configured to display information with a selectable information display orientation; a touch screen system including a touch screen panel, wherein the touch screen panel is associated with the display screen, the touch screen system configured to make a proximate touch detection; and a control circuit coupled to receive proximate touch information from the touch screen system concerning the proximate touch detection, the control circuit configured to interpret that proximate touch information as an indication of a user selection of an information display orientation for the display screen and control the selectable information display orientation in accordance with said user selection.

In an embodiment, a method comprises: making a user proximate touch detection with a touch screen system associated with an information display screen; interpreting the user proximate touch detection as an indication of a user selection of an information display orientation by the information display screen; and controlling a display of information on the information display screen with the user selected information display orientation.

In an embodiment, a system, comprises: a display screen supporting a plurality of information display orientations; a touch screen associated with the display screen, the touch screen configured to sense a proximate touch detection; and a processing circuit coupled to the display screen and capacitive touch screen, said processing circuit configured to interpret the sensed proximate touch detection as a selection by a user as to one of said plurality of information display orientations and control operation of the display screen to display information with the selected one of the plurality of information display orientations.

### BRIEF DESCRIPTION OF THE DRAWINGS

For a better understanding of the embodiments, reference will now be made by way of example only to the accompanying figures in which:

FIG. 1 is a basic block diagram of portable electronic device in accordance with an embodiment;

FIGS. 2A and 2B illustrate operation of the device of FIG. 1 in making a display orientation selection based on a detected gesture;

FIG. 2C illustrates the operation of a touch screen sensor in making a gesture shape detection;

FIGS. 3A and 3B illustrate operation of the device of FIG. 1 in making a display orientation selection based on a detected gesture;

FIG. 3C illustrates the operation of a touch screen sensor in making a gesture movement detection;

FIG. 4 is flow diagram for device operation;

FIGS. 5A and 5B illustrate presentation of information by a display in portrait and landscape modes, respectively.

### DETAILED DESCRIPTION OF THE DRAWINGS

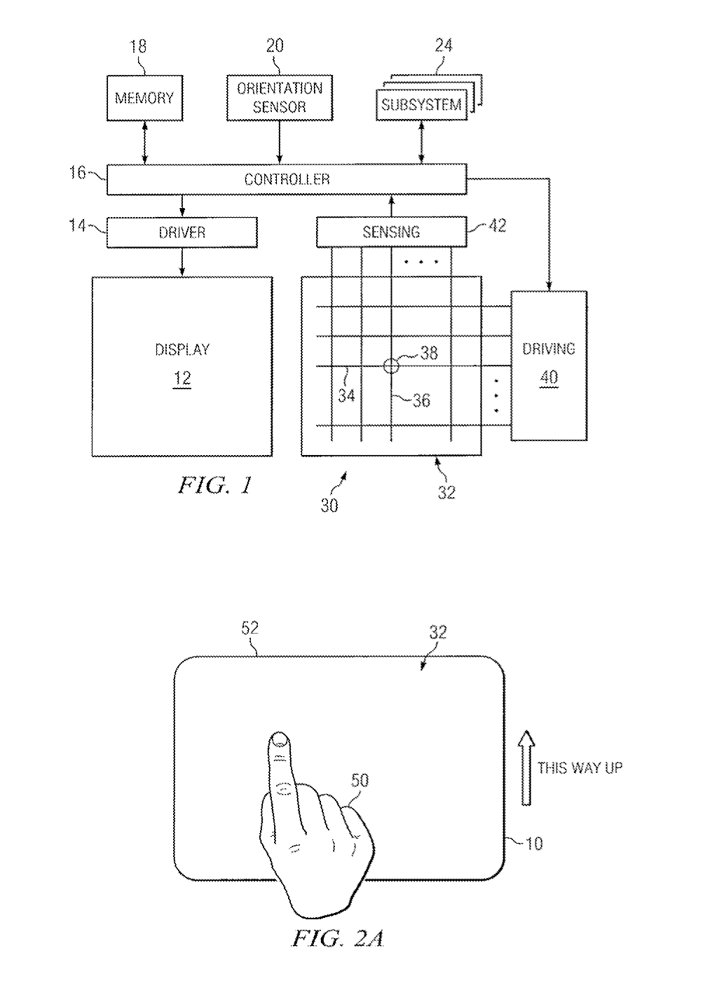

Reference is now made to FIG. 1 which illustrates a basic block diagram of portable electronic device (or product) 10 in accordance with an embodiment. The portable electronic device 10 includes a display screen 12 and display driver circuitry 14 coupled thereto. The display screen 12 may comprise, for example, an LCD screen (or other display technology as known to those skilled in the art). The display screen 12 is preferably of rectangular shape, although this is not a requirement and square or other geometric-shaped display screens could instead be used. The display driver circuitry 14 is configured in a manner well known to those skilled in the art to receive display information and control operation of the display screen to visually present that display information.

The display screen 12 and display driver circuitry 14 are configured to support the presentation of information on the display screen 12 in a plurality of selectable information display orientations. Thus, with consideration of the exemplary rectangularly formatted display screen 12, the display screen 12 and display driver circuitry 14 support selection of an information display orientation in a portrait mode (FIG. 5A) and further support selection of an information display orientation in a landscape mode (FIG. 5B). Again, it will be understood the other display modes may be supported as well, and certain supported display modes may be unique to the geometric shape of the display screen 12.

The portable electronic device 10 further includes a controller 16, for example of the microprocessor type, which controls overall operation of the portable electronic device. The controller 16 is coupled to the display driver circuitry 14 to provide the information for display by the display screen using a selected one of the plurality of supported information display orientations.

The portable electronic device 10 still further includes a memory area 18 for data storage. The memory area 18 is generically presented, it being understood by those skilled in the art that the memory area 18 may be configured to include multiple memories of different type. For example, the memory area 18 may include RAM, RAM, EEPROM, Flash, etc., as needed for the operation of the portable electronic device.

The portable electronic device 10 also includes a device orientation sensor 20. The sensor 20 is preferably an accelerometer or other gravity influenced sensor device, although any other suitable sensor providing device orientation information could be selected. The sensor 20 produces information indicative of the held orientation of the portable electronic device (i.e., the product which incorporates the display screen). This information is communicated to the controller 16. The orientation information is processed by the controller 16 and interpreted to make a determination of a current held orientation of the portable electronic device. Based on this determination, the controller 16 provides control instructions to the display driver circuitry 14 indicative of an information display orientation selection, and the display driver circuitry 14 responds to those control instructions by presenting information on the display screen to the user with that selected information display orientation. Alternatively, the controller 16 may pass the orientation information to the display driver circuitry 14 which will function to interpret the orientation information make a corresponding selection of information display orientation for display screen 12 presentation of display information to the user.

The portable electronic device 10 may still further include one or more device specific subsystems 24 coupled to the controller 16. The device specific subsystem 24 is unique to or required by the type of portable electronic device 10. For example, if the portable electronic device 10 is a smart phone, the device specific subsystem 24 may comprise a wireless communications subsystem for supporting wireless communications over a cellular radio network. Other types of subsystems may include I/O subsystems, user interface subsystems, auxiliary processing subsystems, short range communications (infrared, WiFi, Bluetooth, etc.) subsystems, audio subsystems, and the like.

The portable electronic device 10 also includes a touch screen system 30 of a type well known to those skilled in the art (for example, comprising a capacitive touch screen system or other known touch interface system such as resistive, surface acoustic wave, infrared, piezoelectric, inductive, and visual sensing). The touch screen system 30 includes a touch screen panel 32 that is associated with the display screen 12. For example, the touch screen panel 32 may overlie the display screen 12 or alternatively by integrated within the display screen.

For the exemplary implementation of a capacitive touch screen, the touch screen panel 32 includes a plurality of drive (or force) lines 34 extending in a first direction and a plurality of sense lines 36 extending in a second direction. In a conventional implementation, the second direction is generally oriented perpendicular to the first direction. A sensing cell 38 is formed at each location where a drive line 34 crosses a sense line 36.

The touch screen system 30 further includes a drive circuit 40 that is configured to sequentially apply a drive signal to each of the drive lines 34. As a result, a mutual capacitance is formed at each sensing cell between the drive line 34 and sense line 36. A sensing circuit 42 is coupled to the sense lines 36 and is configured to sense the mutual capacitance at each of the sensing cells 38. In the case where a touch is made to the touch screen panel 32 by a user's finger (or other body part) or a stylus (for example, in the format of a pen), there is a change in the value of the mutual capacitance at one or more of the sensing cells 38. This change in capacitance is detected by the sensing circuit 42 and communicated to the controller 16 as a user interface control signal.

It is understood by those skilled in the art that a detectable change in the value of the mutual capacitance at one or more of the sensing cells 38 occurs not only with respect to an actual physical touch of made to the touch screen panel 32, but also with respect to a proximate passing of user's finger (or other body part) or a stylus (for example, in the format of a pen) over the touch screen panel 32 without making direct contact. For example, the capacitive touch screen system 30 may be configured in a manner known in the art to support the making of a “proximate” detection of an approaching or hovering finger (or other body part such as a hand) or a stylus. The capacitive touch screen system 30 may have sensitivity sufficient to make a “proximate” detection from as far away as 3-5 cm. This capability is advantageously used in the portable electronic device 10 to over-ride an information display orientation selection sensor of the portable electronic device and exercise control over selection of the information display orientation. Thus, in the context of this disclosure, the phrase “proximate touch detection” or the like is understood to mean a capacitive sensing (of an approaching or hovering finger or other body part, or a stylus, or other substance) that does not result from physical contact being made with the touch screen panel 32.

As a default operation, the information provided by the device orientation sensor 20 is interpreted (either in the controller 16 or display driver circuitry 14) as discussed above to make a corresponding selection of information display orientation for the presentation of information by the display screen to the user. However, using the proximity sensing capabilities of the capacitive touch screen system 30, the user may further control selection of information display orientation by making a gesture using an approaching or hovering finger (or other body part such as a hand) or a stylus with this gesture. A proximate touch detection is made of this gesture with that detection interpreted to discern a selection being made by the user of a specific one of a plurality of information display orientations supported by the device.

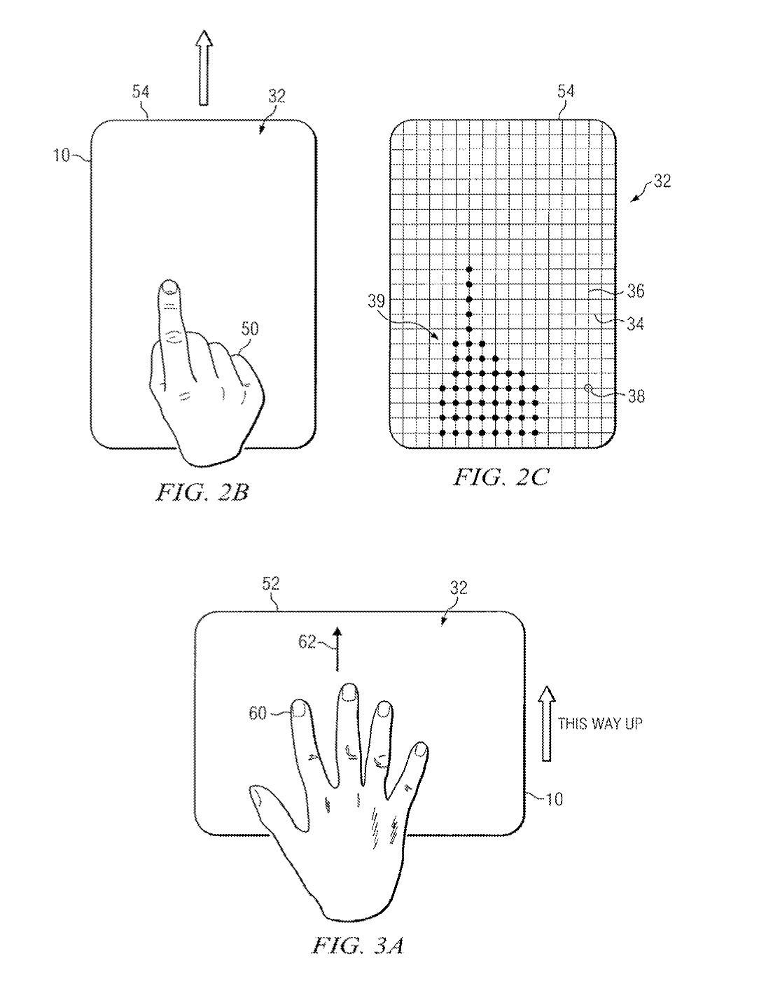

An example of this is illustrated in FIGS. 2A and 2B. The user produces a pointing finger gesture 50 and hovers this gesture over the touch screen panel 32. The sensing circuit 42 senses change in capacitance due to the shape of the hovering pointing finger gesture. The controller 16 processes the sensed change in capacitance at specific ones of the sensing cells 38 to deduce the shape of the hovering gesture 50, recognize the pointing orientation of the gesture, and then interprets the gesture as an indication by the user that the display screen should be oriented with “up” in the direction of the pointing finger. The detected hovering pointing finger gesture thus provides a special user interface control signal concerning information display orientation selection. FIG. 2A illustrates the detected gesture 50 indicating selection of the information display orientation for landscape mode with edge 52 as the top edge of the display screen 12 (so that information is displayed as shown in FIG. 5B), while FIG. 2B illustrates the detected gesture 50 indicating selection of the information display orientation for portrait mode with edge 54 as the top edge of the display screen 12 (so that information is displayed as shown in FIG. 5A). The controller 16 accordingly instructs the display driver circuitry 14 to present display information to the user with the information display orientation indicated by the detected hovering pointing finger gesture. It will be understood that the proximate touch detection may further include a time component, with the proximate touch detection and deduction of shape having to be held for a sufficient amount of time (samples or frames) before the interpretation of the gesture as an indication by the user of an information display orientation selection is confirmed.

Reference is now made to FIG. 2C which illustrates the operation of the touch screen panel 32 in making a gesture shape detection. FIG. 2C illustrates the use of numerous drive (or force) lines 34 and sense lines 36, it being understood that a typical touch screen panel 32 will likely have many more lines than illustrated. It will be recalled that the presence of an approaching or hovering finger (or other body part such as a hand) or a stylus over the touch screen panel 32 will cause variation in the value of the mutual capacitance at one or more of the sensing cells 38 proximate to the approaching or hovering finger (or other body part such as a hand) or a stylus. The change in mutual capacitance value is sensed by the sensing circuit 42 and communicated to the controller 16 where the interpretation of the sensed capacitance values is performed (including, if desired, a held time component evaluation). The change in sensed mutual capacitance value the sensing cells 38 is illustrated in FIG. 2C by the shading 39 in of those sensing cells 38 which are proximate to approaching or hovering finger (or other body part such as a hand) or a stylus. The array of sensed capacitance value information that is passed from the sensing circuit 42 to the controller 16 accordingly provides a map of the shape of the approaching or hovering finger (or other body part such as a hand) or a stylus which can easily be interpreted by the controller 16 in the manner described above to indicate a user selection of an information display orientation. FIG. 2C accordingly presents a detected gesture which a shape indicating the user's selection of portrait display orientation with edge 54 on top (see, FIG. 2B and FIG. 5A).

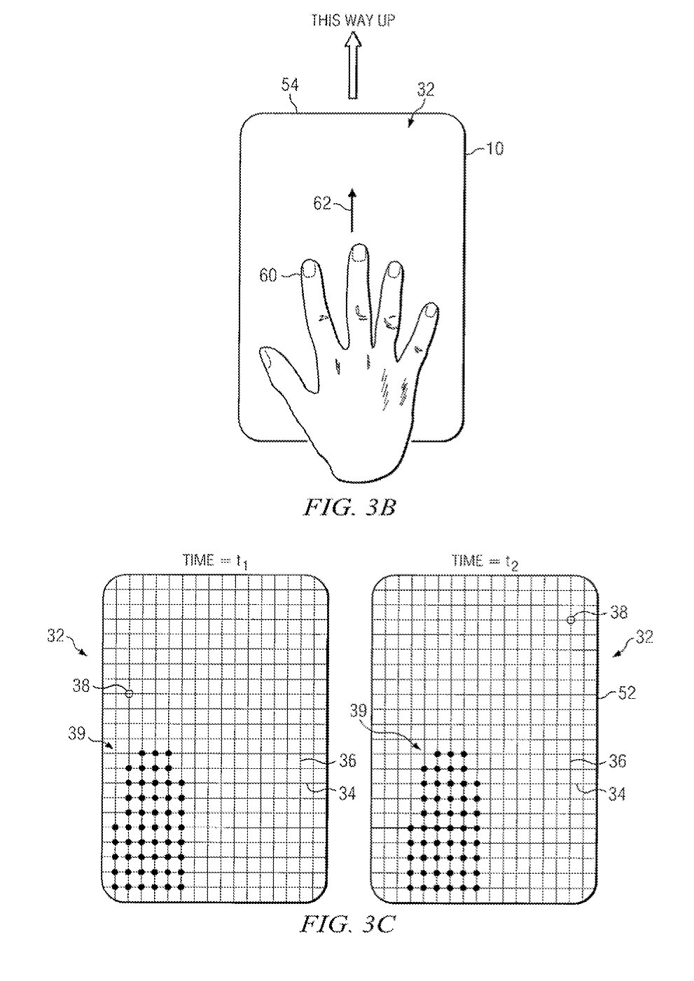

It will be understood that a pointing finger gesture 50 is only one example of a gesture that could be detected and used to make an information display orientation selection. As another example, a hovering gesture of any shape coupled with movement of the gesture could be detected as an indication by the user of an information display orientation selection. An example of this is illustrated in FIGS. 3A and 3B. The user produces a generic hand gesture 60 and passes (with movement 62) this gesture proximately over the touch screen panel 32. The sensing circuit 42 senses change in capacitance across the touch screen panel 32 over time due to the movement 62 of the proximately located gesture. The controller 16 interprets the sensed change in capacitance at the sensing cells 38 to deduce the direction of movement 62 for the gesture 60 and interprets the gesture movement as an indication by the user that the display screen should be oriented with “up” in the direction of that movement. The detected gesture movement 62 thus provides a special user interface control signal concerning information display orientation selection. FIG. 3A illustrates the detected gesture 60 with movement 62 indicating selection of the information display orientation for landscape mode with edge 52 as the top edge of the display screen 12, while FIG. 3B illustrates the detected gesture 60 with movement 62 indicating selection of the information display orientation for portrait mode with edge 54 as the top edge of the display screen 12. The controller 16 accordingly instructs the display driver circuitry 14 to present display information to the user with the information display orientation indicated by the detected gesture movement 62.

Reference is now made to FIG. 3C which illustrates the operation of the touch screen panel 32 in making a gesture movement detection. FIG. 3C illustrates the use of numerous drive (or force) lines 34 and sense lines 36, it being understood that a typical touch screen panel 32 will likely have many more lines than illustrated. It will be recalled that the presence of an approaching or hovering finger (or other body part such as a hand) or a stylus over the touch screen panel 32 will cause variation in the value of the mutual capacitance at one or more of the sensing cells 38 proximate to the approaching or hovering finger (or other body part such as a hand) or a stylus. The change in mutual capacitance value is sensed by the sensing circuit 42 and communicated to the controller 16 where the interpretation of the sensed capacitance values is performed. The change in sensed mutual capacitance value the sensing cells 38 is illustrated in FIG. 3C by the shading 39 in of those sensing cells 38 which are proximate to approaching or hovering finger (or other body part such as a hand) or a stylus. FIG. 3C illustrates the change in sensed mutual capacitance value at two different sampling (frame) instants, time t₁ and time t₂ (it being understood that the illustrated sampling instants need not be considered to be consecutive samples and need not be the only samples considered). The array of sensed capacitance value information that is passed from the sensing circuit 42 to the controller 16 at each sampling instant accordingly provides an indication of the presence of a finger (or other body part such as a hand) or a stylus. Evaluation of the sensed capacitance value information at the at least two sampling instants can easily be interpreted by the controller 16 in the manner described above to detect movement (including direction of movement) which is indicative of a user selection of a information display orientation. FIG. 3C accordingly presents a detection of gesture movement over time indicating the user's selection of a landscape display orientation with edge 52 on top (see, FIG. 3A and FIG. 5B).

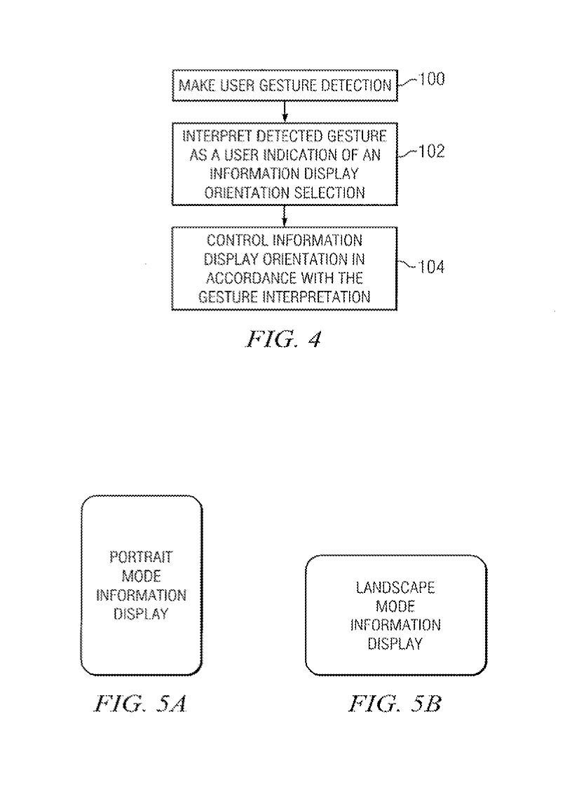

Reference is now made to FIG. 4 which illustrates a flow diagram for device operation. In step 100, device makes a user gesture detection. As discussed above, this gesture detection is made through use of a capacitive touch screen system operable to not only detect a physical touching of the touch screen but is further operable to make a proximate touch detection of the type where no physical contact is made with the touch screen. This type of detection is sometimes referred to in the art as a hovering detection. The gesture detection that is made in step 100 is of the proximate touch type and may comprise a shape detection, a movement detection or the combination of a movement and shape detection (see, FIGS. 2A, 2B, 3A and 3C). Specifically, a finger, hand, other body part and/or stylus may be implicated in forming the gesture.

In step 102, the detected user gesture is interpreted as an indication from the user of the making of an information display orientation selection. This interpretation with respect to a detected gesture shape may comprise interpreting the shape (such as a detected finger pointing direction) as indicative of the selected orientation. This interpretation with respect to a detected gesture movement may comprise interpreting the direction of movement as indicative of the selected orientation. The combination of shape detection with movement direction detection may also be preferred in step 102 as a means for ensuring that the detected user gesture is in fact indicating a user selection of an information display orientation, and not an indication of some other action or just an accident.

In step 104, the orientation of the information presented on the display screen is controlled in accordance with the interpretation of the detected user gesture. Thus, if the detected user gesture is interpreted as an indication to place the display screen in portrait mode, the operation in step 104 will cause the display driver circuitry to control the display screen to present the display information with the selected portrait mode orientation. Conversely, if the detected user gesture is interpreted as an indication to place the display screen in landscape mode, the operation in step 104 will cause the display driver circuitry to control the display screen to present the display information with the selected landscape mode orientation.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

What is claimed is:

1. A system, comprising:
a display screen configured to display information with a selectable information display orientation;
a touch screen system including a touch screen panel, wherein the touch screen panel is associated with the display screen, the touch screen system configured to make a proximate touch detection; and
a control circuit coupled to receive proximate touch information from the touch screen system concerning the proximate touch detection, the control circuit configured to interpret that proximate touch information as an indication of a user selection of an information display orientation for the display screen and control the selectable information display orientation in accordance with said user selection.

2. The system of claim 1, wherein the proximate touch detection is a hovering detection, and the hovering detection is interpreted to indicate the user selection of the information display orientation.

3. The system of claim 2, wherein the proximate touch detection is further a detection of a shape for the hovering detection, and the shape detection is interpreted to indicate the user selection of the information display orientation.

4. The system of claim 3, wherein the proximate touch detection is further a detection of movement for the hovering detection, and the movement detection is interpreted to indicate the user selection of the information display orientation.

5. The system of claim 1, wherein the proximate touch detection is further a detection of movement for the proximate touch detection, and the movement detection is interpreted to indicate the user selection of the information display orientation.

6. The system of claim 1, wherein the proximate touch detection is made by sensing changes in capacitance at the touch screen panel.

7. The system of claim 1, further comprising an orientation sensor configured to detect an orientation of a product incorporating the system, wherein the control circuit is coupled to receive orientation information from the orientation sensor and configured to control the selectable information display orientation in accordance with said orientation information.

8. The system of claim 7, wherein the control circuit is further configured to over-ride selection of information display orientation in accordance with the orientation information and instead control selection of the information display orientation in accordance with said user selection as interpreted from the proximate touch information.

9. The system of claim 1, wherein the touch screen system is a capacitive touch screen system.

10. A method, comprising:
making a user proximate touch detection with a touch screen system associated with an information display screen;
interpreting the user proximate touch detection as an indication of a user selection of an information display orientation by the information display screen; and
controlling a display of information on the information display screen with the user selected information display orientation.

11. The method of claim 10, wherein the proximate touch detection is a hovering detection, and wherein interpreting comprises interpreting the hovering detection to indicate selection of a particular one of a plurality of information display orientations supported by the information display screen.

12. The method of claim 11, wherein the proximate touch detection is further a detection of a shape for the hovering detection, and wherein interpreting comprises interpreting the shape detection to indicate selection of a particular one of a plurality of information display orientations supported by the information display screen.

13. The method of claim 12, wherein the proximate touch detection is further a detection of movement for the hovering detection, and wherein interpreting comprises interpreting the movement detection to indicate selection of a particular one of a plurality of information display orientations supported by the information display screen.

14. The method of claim 10, wherein the proximate touch detection is further a detection of movement for the proximate touch detection, and wherein interpreting comprises interpreting the movement detection is interpreted to indicate selection of a particular one of a plurality of information display orientations supported by the information display screen.

15. The method of claim 10, wherein controlling the display comprises controlling a display driver circuit coupled to the information display screen so as to present the information on the information display screen with the selected information display orientation.

16. The method of claim 10, further comprising:
sensing an orientation of a product incorporating the information display screen; and
selecting the display of information on the information display screen with an information display orientation in accordance the sensed orientation.

17. The method of claim 16, wherein controlling the display of information comprises over-riding the selection to display information on the information display screen with the user selected information display orientation.

18. A system, comprising:
a display screen supporting a plurality of information display orientations;
a touch screen associated with the display screen, the touch screen configured to sense a proximate touch detection; and
a processing circuit coupled to the display screen and touch screen, said processing circuit configured to interpret the sensed proximate touch detection as a selection by a user as to one of said plurality of information display orientations and control operation of the display screen to display information with the selected one of the plurality of information display orientations.

19. The system of claim 18, further comprising an orientation sensor configured to detect an orientation of a product incorporating the system, wherein the processing circuit is coupled to receive orientation information from the orientation sensor and configured to select one of said plurality of information display orientations in accordance with said orientation information.

20. The system of claim 19, wherein the processing circuit is further configured to control operation of the display screen to display information with the information display orientation selected in accordance with the sensed proximate touch detection instead of the information display orientation selected in accordance with the orientation information.

21. The system of claim 18, wherein the proximate touch detection is one of a shape detection or a movement detection.

22. The system of claim 18, wherein the touch screen is a capacitive touch screen.
